(19) United States
(12) Patent Application Publication
(10) Pub. No.: US 2025/0139048 A1
(43) Pub. Date: May 1, 2025

(54) MAXIMIZING BANDWIDTH UTILIZATION BY SELECTING APPROPRIATE MODE OF OPERATION FOR PCIe CARD

(71) Applicant: International Business Machines Corporation, Armonk, NY (US)

(72) Inventors: Patrick James McKeone, Beacon, NY (US); Faezeh Gholami, Ridgewood, NJ (US); John S. Werner, Fishkill, NY (US); Rafaela Frota, Poughkeepsie, NY (US); Andrew C. M. Hicks, Highland, NY (US)

(21) Appl. No.: 18/385,476

(22) Filed: Oct. 31, 2023

(51) Int. Cl. G06F 13/42

(52) U.S. Cl. CPC G06F 13/4282; G06F 2213/0026

(57) ABSTRACT

A computer-implemented method, system, and computer program product for maximizing bandwidth utilization of PCIe links. The bandwidth utilization of a PCIe link involving a PCIe card is measured. A bandwidth utilization of the PCIe link at a future time is predicted based on the measured bandwidth utilization of the PCIe link using a machine learning model trained to predict bandwidth utilization of PCIe links. If the predicted bandwidth utilization of the PCIe link exceeds a threshold value, then the PCIe card is configured to implement a first mode of operation that utilizes more bandwidth if not implementing the first mode of operation at the future time. If the predicted bandwidth utilization of the PCIe link does not exceed a threshold value, then the PCIe card is configured to implement a second mode of operation that utilizes less bandwidth if not implementing the second mode of operation at the future time.

### TECHNICAL FIELD

The present disclosure relates generally to Peripheral Component Interconnect Express (PCIe), and more particularly to maximizing the bandwidth utilization of a PCIe link by selecting the appropriate mode of operation (e.g., high bandwidth mode of operation) for the PCIe card involving the PCIe link.

### BACKGROUND

PCI Express (Peripheral Component Interconnect Express), officially abbreviated as PCIe, is a high-speed serial computer expansion bus standard, designed to replace the older PCI, PCI-X and AGP bus standards. It is the common motherboard interface for personal computers' graphics cards, sound cards, hard disk drive host adapters, SSDs (solid state drives), Wi-Fi, and Ethernet hardware connections. PCIe has numerous improvements over the older standards, including higher maximum system bus throughput, lower I/O pin count and smaller physical footprint, better performance scaling for bus devices, a more detailed error detection and reporting mechanism (Advanced Error Reporting, AER), and native hot-swap functionality.

### SUMMARY

In one embodiment of the present disclosure, a computer-implemented method for maximizing bandwidth utilization of Peripheral Component Interconnect Express (PCIe) links comprises measuring a bandwidth utilization of a PCIe link involving a PCIe card. The method further comprises predicating a bandwidth utilization of the PCIe link based on the measured bandwidth utilization of the PCIe link using a machine learning model trained to predict bandwidth utilizations of PCIe links. The method additionally comprises switching a mode of operation of the PCIe card based on the predicted bandwidth utilization of the PCIe link.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components used by the computing device to maximize the bandwidth utilization of a PCIe link by selecting the appropriate mode of operation for the PCIe card in accordance with an embodiment of the present disclosure;

FIG. 3 illustrates the storage of the configuration settings in the memory of the PCIe card in accordance with an embodiment of the present disclosure;

FIG. 4 illustrates an embodiment of the present disclosure of the hardware configuration of the computing device which is representative of a hardware environment for practicing the present disclosure;

FIG. 5 is a flowchart of a method for training a machine learning model to predict the bandwidth utilization of PCIe links in accordance with an embodiment of the present disclosure; and

FIG. 6 is a flowchart of a method for maximizing the bandwidth utilization of PCIe links in accordance with an embodiment of the present disclosure.

### DETAILED DESCRIPTION

As stated above, PCI Express (Peripheral Component Interconnect Express), officially abbreviated as PCIe, is a high-speed serial computer expansion bus standard, designed to replace the older PCI, PCI-X and AGP bus standards. It is the common motherboard interface for personal computers' graphics cards, sound cards, hard disk drive host adapters, SSDs (solid state drives), Wi-Fi, and Ethernet hardware connections. PCIe has numerous improvements over the older standards, including higher maximum system bus throughput, lower I/O pin count and smaller physical footprint, better performance scaling for bus devices, a more detailed error detection and reporting mechanism (Advanced Error Reporting, AER), and native hot-swap functionality.

Conceptually, the PCIe bus is a high-speed serial replacement of the older PCI/PCI-X bus. One of the key differences between the PCI Express bus and the older PCI is the bus topology. PCI uses a shared parallel bus architecture in which the PCI host and all devices share a common set of address, data, and control lines. In contrast, PCI Express is based on point-to-point topology, with separate serial links connecting every device to the root complex (host). Because of its shared bus topology, access to the older PCI bus is arbitrated (in the case of multiple masters), and limited to one master at a time, in a single direction. Furthermore, the older PCI clocking scheme limits the bus clock to the slowest peripheral on the bus (regardless of the devices involved in the bus transaction). In contrast, a PCIe bus link supports full-duplex communication between any two endpoints with no inherent limitation on concurrent access across multiple endpoints.

PCIe devices, such as PCIe cards, communicate via a logical connection called an interconnect or a link. A link is a point-to-point communication channel between two PCI Express ports allowing both of them to send and receive ordinary PCI requests (configuration, I/O or memory read/write) and interrupts (INTx, MSI or MSI-X). At the physical level, a link is composed of one or more lanes. A lane is composed of two differential signaling pairs with one pair for receiving data and the other for transmitting. Thus, each lane is composed of four wires or signal traces. Conceptually, each lane is used as a full-duplex byte stream, transporting data packets in eight-bit “byte” format simultaneously in both directions between endpoints of a link. Physical PCI Express links may contain 1, 4, 8, or 16 lanes.

As discussed above, PCIe cards communicate with a logical connection called an interconnect or link. A PCIe card is a network adapter with a PCIe interface. PCIe cards are designed to fit into PCIe-based slots, such as slots in the motherboard of devices, such as a host, server, network switch, etc. A PCIe card implements the PCIe protocol. As a result, after inserting a PCIe card, a logical connection (“link”) will be formed between the PCIe card and the motherboard enabling a point-to-point communication channel between the two PCIe ports and allowing both of them to send and receive ordinary PCI requests and interrupts.

There are various generations or versions of PCIe, such as PCIe 1.0, PCIe 2.0, PCIe 3.0, PCIe 4.0, PCIe 5.0, and PCIe 6.0. Higher PCIe versions or generations utilize more power than previous generations, which have slower signaling rates. Each PCIe version supports roughly double the bandwidth of the previous version of PCIe. As a result, during times of low bandwidth utilization, such higher versions or generations of PCIe have available bandwidth which is not being used. During such situations, power is being wasted.

Unfortunately, there is not currently a means for limiting or preventing such wasted power.

The embodiments of the present disclosure provide a means for limiting or preventing such wasted power by switching modes of operation of the PCIe card such that the PCIe card switches to a mode of operation that uses less power during a period of predicted low bandwidth utilization and switches to a mode of operation that uses more power during a period of predicted high bandwidth utilization. In one embodiment, a machine learning model is built and trained to predict a bandwidth utilization of a PCIe link involving a PCIe card. Upon measuring a bandwidth utilization of a PCIe link involving a PCIe card, such a measurement is used by the trained machine learning model to predict the bandwidth utilization of the PCIe link. If the predicted measurement of the bandwidth utilization of the PCIe link exceeds a threshold value, then the PCIe card should be operating in a first mode of operation (e.g., a higher version or generation of PCIe) that utilizes more bandwidth. If, on the other hand, the predicted measurement of the bandwidth utilization of the PCIe link does not exceed the threshold value, then the PCIe card should be operating in a second mode of operation (e.g., a lower version or generation of PCIe) that utilizes less bandwidth. By ensuring that the PCIe card is operating in the appropriate mode of operation based on the predicted bandwidth utilization of the PCIe link, the bandwidth utilization of the PCIe link is maximized and the amount of power wasted is minimized. These and other features will be discussed in further detail below.

In some embodiments of the present disclosure, the present disclosure comprises a computer-implemented method, system, and computer program product for maximizing bandwidth utilization of Peripheral Component Interconnect Express (PCIe) links. In one embodiment of the present disclosure, the bandwidth utilization of a PCIe link involving a PCIe card is measured. In one embodiment, such a bandwidth utilization is provided in terms of a percentage of a link transfer rate, such as 70% of the link transfer rate. In one embodiment, such a bandwidth utilization is provided in terms of bytes per second (e.g., 64 GB/s). A bandwidth utilization of the PCIe link at a future time is predicted based on the measured bandwidth utilization of the PCIe link using a machine learning model trained to predict bandwidth utilization of PCIe links. If the predicted bandwidth utilization of the PCIe link exceeds a threshold value, then the mode of operation of the PCIe card is switched to implement a first mode of operation (e.g., a higher version or generation of PCIe) that utilizes more bandwidth if not implementing the first mode of operation at the future time. If the predicted bandwidth utilization of the PCIe link does not exceed a threshold value, then the mode of operation of the PCIe card is switched to implement a second mode of operation (e.g., a lower version or generation of PCIe) that utilizes less bandwidth if not implementing the second mode of operation at the future time. In this manner, the bandwidth utilization of the PCIe link is maximized and the amount of power wasted is minimized.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

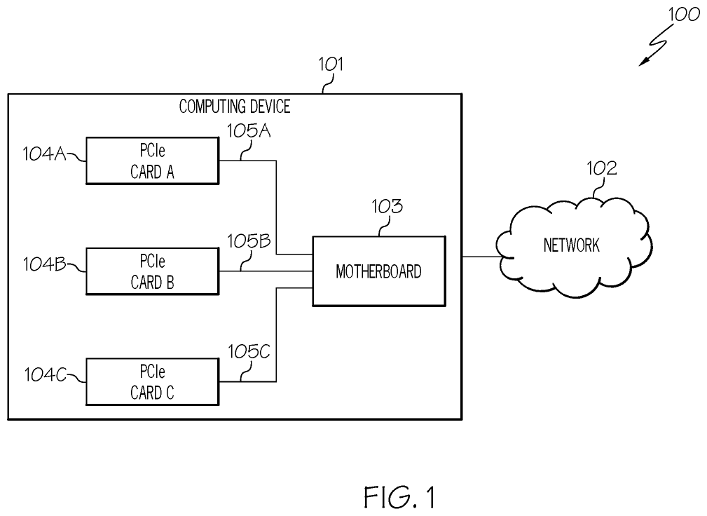

Referring now to the Figures in detail, FIG. 1 illustrates an embodiment of the present disclosure of a communication system 100 for practicing the principles of the present disclosure. Communication system 100 includes a computing device 101 connected to other devices (not shown) via a network 102.

Computing device 101 may be any type of computing device (e.g., portable computing unit, Personal Digital Assistant (PDA), laptop computer, mobile device, tablet personal computer, smartphone, mobile phone, navigation device, gaming unit, desktop computer system, workstation, Internet appliance and the like) configured with the capability of connecting to network 102 and consequently communicating with other computing devices 101 and other devices (not shown). It is noted that both computing device 101 and the user of computing device 101 may be identified with element number 101.

Network 102 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

In one embodiment, computing device 101 implements the Peripheral Component Interconnect Express (PCIe) protocol used for connecting various internal components (peripherals) in computing device 101. For example, PCIe may be used for connecting peripherals or PCIe devices, such as graphics cards, network cards, storage controllers, etc., to a motherboard 103 of computing device 101. A motherboard 103, as used herein, refers to the main printed circuit board, which holds and allows communication between many of the crucial electronic components of computing device 101, such as the central processing unit (CPU) and memory, and provides connectors for other peripherals, such as PCIe devices.

In one embodiment, motherboard 103 includes PCIe slots, which come in different sizes or configurations (denoted by an “x” followed by a number), referred to as “lanes.” Common slot configurations include ×1, ×4, ×8, and ×16, which represent the number of data lanes available for communication. A higher number of lanes generally results in higher data transfer rates between the motherboard and the expansion card.

As illustrated in FIG. 1, computing device 101 includes PCIe cards 104A-104C (identified as “PCIe Card A,” “PCIe Card B,” and “PCIe Card C,” respectively, in FIG. 1). PCIe cards 104A-104C may collectively or individually be referred to as PCIe cards 104 or PCIe card 104, respectively. While FIG. 1 illustrates computing device 101 containing three PCIe cards 104, computing device 101 may contain any number of PCIe cards 104.

PCIe card 104, as used herein, is an expansion card that connects to motherboard 103 using a PCIe slot (not shown). PCIe cards 104 are used to enhance the functionality of computing device 101 by adding various capabilities that are not integrated into motherboard 103 itself. PCIe cards 104 come in different forms, and each type serves a specific purpose. Some common types of PCIe cards 104, can include, but are not limited to, graphics card, network interface card, USB (universal serial bus) card, storage controller card, sound card, capture card, etc.

PCIe cards 104 communicate via a logical connection called an interconnect or a link (referred to herein as the “PCIe link”). A PCIe link, as used herein, is a point-to-point communication channel between two PCI Express ports allowing both of them to send and receive ordinary PCI requests (configuration, I/O or memory read/write) and interrupts (INTx, MSI or MSI-X). That is, a PCIe link is a physical connection between two devices, such as PCIe card 104 and motherboard 103 as illustrated in FIG. 1. For example, PCIe link 105A is a physical connection between PCIe card 104A and motherboard 103. PCIe link 105B is a physical connection between PCIe card 104B and motherboard 103. Furthermore, PCIe link 105C is a physical connection between PCIe card 104C and motherboard 103. PCIe links 105A-105C may collectively or individually be referred to as PCIe links 105 or PCIe link 105, respectively. While FIG. 1 illustrates three PCIe links 105, computing device 101 may utilize any number of PCIe links 105.

At the physical level, PCIe link 105 is composed of one or more lanes. A lane is composed of two differential signaling pairs, with one pair for receiving data and the other for transmitting. Thus, each lane is composed of four wires or signal traces. Conceptually, each lane is used as a full-duplex byte stream, transporting data packets in eight-bit “byte” format simultaneously in both directions between the endpoints of PCIe link 105. Physical PCIe links 105 may contain 1, 4, 8, or 16 lanes.

A PCIe lane is a single data channel within a PCIe slot or connection that provides a pathway for transmitting and receiving data, such as between motherboard 103 and PCIe card 104. The term “lane,” as used herein, refers to a set of differential signal pairs (transmit and receive) that work together to transmit data.

The number of PCIe lanes in a slot or connection determines the available bandwidth for data transfer, such as between motherboard 103 and PCIe card 104. More lanes generally mean higher data transfer rates and better performance. Each PCIe lane consists of multiple wires or traces that are designed to minimize signal interference and maintain data integrity at high speeds.

As discussed above, there are various generations or versions of PCIe, such as PCIe 1.0, PCIe 2.0, PCIe 3.0, PCIe 4.0, PCIe 5.0, and PCIe 6.0. Higher PCIe versions or generations utilize more power than previous generations, which have slower signaling rates. Each PCIe version supports roughly double the bandwidth of the previous version of PCIe. As a result, during times of low bandwidth utilization, such higher versions or generations of PCIe have available bandwidth which is not being used. During such situations, power is being wasted.

Computing device 101 is configured to limit or prevent such wasted power by switching modes of operation of PCIe card 104 such that PCIe card 104 switches to a mode of operation that uses less power during a period of predicted low bandwidth utilization and switches to a mode of operation that uses more power during a period of predicted high bandwidth utilization. That is, computing device 101 is configured to maximize the bandwidth utilization by selecting the appropriate mode of operation for PCIe card 104.

In one embodiment, a machine learning model is built and trained to predict a bandwidth utilization of PCIe link 105 involving PCIe card 104. PCIe link 105, as used herein, refers to a point-to-point communication channel between two PCI Express ports allowing both of them to send and receive ordinary PCI requests (configuration, I/O or memory read/write) and interrupts (INTx, MSI or MSI-X). At the physical level, a link is composed of one or more lanes. A lane is composed of two differential signaling pairs, with one pair for receiving data and the other for transmitting. Thus, each lane is composed of four wires or signal traces. Conceptually, each lane is used as a full-duplex byte stream, transporting data packets in eight-bit “byte” format simultaneously in both directions between the endpoints of a link. Physical PCI Express links may contain 1, 4, 8, or 16 lanes.

In one embodiment, upon measuring a bandwidth utilization of PCIe link 105 involving PCIe card 104, such a measurement is used by the trained machine learning model to predict the bandwidth utilization of PCIe link 105. If the predicted measurement of the bandwidth utilization of PCIe link 105 exceeds a threshold value, then PCIe card 104 should be operating in a first mode of operation (e.g., a higher version or generation of PCIe) that utilizes more bandwidth. If, on the other hand, the predicted measurement of the bandwidth utilization of PCIe link 105 does not exceed the threshold value, then PCIe card 104 should be operating in a second mode of operation (e.g., a lower version or generation of PCIe) that utilizes less bandwidth. By ensuring that PCIe card 104 is operating in the appropriate mode of operation based on the predicted bandwidth utilization of PCIe link 105, the bandwidth utilization of PCIe link 105 is maximized and the amount of power wasted is minimized. These and other features will be discussed in further detail below.

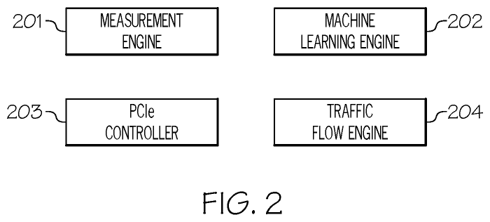

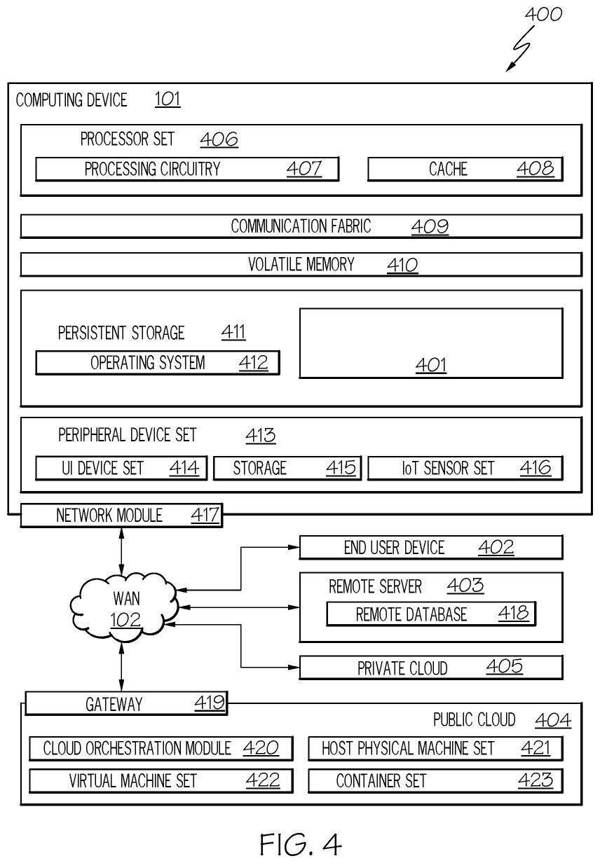

A description of the software components of computing device 101 used for maximizing the bandwidth utilization of PCIe link 105 by selecting the appropriate mode of operation for PCIe card 104 is provided below in connection with FIG. 2. A description of the hardware configuration of computing device 101 is provided further below in connection with FIG. 4.

System 100 is not to be limited in scope to any one particular network architecture. System 100 may include any number of computing devices 101 and networks 102.

A discussion regarding the software components used by computing device 101 for maximizing the bandwidth utilization of PCIe link 105 by selecting the appropriate mode of operation for PCIe card 104 is provided below in connection with FIG. 2.

FIG. 2 is a diagram of the software components used by computing device 101 to maximize the bandwidth utilization of PCIe link 105 by selecting the appropriate mode of operation for PCIe card 104 in accordance with an embodiment of the present disclosure.

Referring to FIG. 2, in conjunction with FIG. 1, computing device 101 includes a measurement engine 201 configured to track the bandwidth utilization over a period of time (e.g., a week, a month) for each PCIe link 105 established by each PCIe card 104. Bandwidth utilization, as used herein, refers to the rate at which data can flow through PCIe link 105. In one embodiment, such a bandwidth utilization is provided in terms of a percentage of a link transfer rate, such as 70% of the link transfer rate. In one embodiment, such a bandwidth utilization is provided in terms of bytes per second (e.g., 64 GB/s). Measurement engine 201 may utilize various tools for tracking the bandwidth utilization for each PCIe link 105 including, but are not limited to, Intel® Performance Counter Monitor, 3DMark®, Libre Hardware Monitor, etc.

In one embodiment, by measurement engine 201 tracking the bandwidth utilization of PCIe link 105 over a period of time, such information may be used to train a machine learning model to predict the bandwidth utilization of PCIe link 105, such as at a particular future moment in time, based on a currently measured bandwidth utilization of PCIe link 105 as discussed further below.

In one embodiment, measurement engine 201 measures the bandwidth utilization of PCIe link 105 (e.g., PCIe link 105A) involving a PCIe card 104 (e.g., PCIe card 104A) at a current moment in time. In one embodiment, such a bandwidth utilization is provided in terms of a percentage of a link transfer rate, such as 70% of the link transfer rate. In one embodiment, such a bandwidth utilization is provided in terms of bytes per second (e.g., 64 GB/s). Measurement engine 201 may utilize various tools for measuring the bandwidth utilization for PCIe link 105 (e.g., PCIe link 105A) at a current moment in time including, but are not limited to, Intel® Performance Counter Monitor, 3DMark®, Libre Hardware Monitor, etc.

Computing device 101 further includes a machine learning engine 202 configured to build and train a machine learning model to predict the bandwidth utilization of PCIe links 105 at a future moment in time using the tracked bandwidth utilization for each PCIe link 105. Such a prediction for the bandwidth utilization of PCIe link 105 (e.g., PCIe link 105A) is provided by the machine learning model based on inputting to the trained machine learning model a currently measured bandwidth utilization of PCIe link 105 (e.g., PCIe link 105A).

In one embodiment, the machine learning model is trained to predict the bandwidth utilization of PCIe link 105 at a future moment in time based on a sample data set that includes the tracked bandwidth utilization of PCIe link 105 over a period of time. Such a sample data set may be stored in a data structure (e.g., table) residing within the storage device of computing device 101.

Furthermore, in one embodiment, the sample data set discussed above is referred to herein as the “training data,” which is used by a machine learning algorithm to make predictions as to the bandwidth utilization of PCIe link 105. The algorithm iteratively makes predictions on the training data as to the predicted bandwidth utilization of PCIe link 105 until the predictions achieve the desired accuracy as determined by an expert. Examples of such learning algorithms include nearest neighbor, Naïve Bayes, decision trees, linear regression, support vector machines, and neural networks.

After such a machine learning model is trained, it may be utilized by PCIe controller 203 of computing device 101 to predict the bandwidth utilization of PCIe link 105 (e.g., PCIe link 105A) based on the measured bandwidth utilization, such as the currently measured bandwidth utilization of PCIe link 105 (e.g., PCIe link 105A). In one embodiment, such a measured bandwidth utilization, such as the currently measured bandwidth utilization of PCIe link 105 (e.g., PCIe link 105A), is inputted into the trained machine learning model, which outputs a predicted bandwidth utilization of PCIe link 105 (e.g., PCIe link 105A) at a future time (e.g., next hour), which may be user-designated.

In one embodiment, PCIe controller 203 is configured to determine if the predicted bandwidth utilization of PCIe link 105 exceeds a threshold value, which may be user-designated. In one embodiment, such a threshold value may be in terms of a percentage of a link transfer rate, such as 70% of the link transfer rate. In one embodiment, such a threshold value may be in terms of bytes per second (e.g., 64 GB/s).

In one embodiment, PCIe controller 203 determines if the predicted bandwidth utilization of PCIe link 105 exceeds the threshold value in order to determine which mode of operation should be utilized by PCIe card 104 forming such a PCIe link 105. In one embodiment, PCIe card 104 may operate in two different modes of operation, such as a high bandwidth mode of operation and a low bandwidth mode of operation. A high bandwidth mode of operation, as used herein, refers to a mode of operation of PCIe card 104 that involves a higher version or generation of PCIe that utilizes more bandwidth. For example, such a higher version or generation of PCIe, such as PCIe 6.0, may correspond to a bandwidth utilization rate of 128 GB/s. A low bandwidth mode of operation, as used herein, refers to a mode of operation of PCIe card 104 that involves a lower version or generation of PCIe that utilizes less bandwidth. For example, such a lower version or generation of PCIe, such as PCIe 4.0, may correspond to a bandwidth utilization rate of 32 GB/s. While the following discusses two modes of operation, it is noted that the principles of the present disclosure may utilize any number of modes of operation, where the utilization of each mode of operation is determined based on a predicted bandwidth utilization of PCIe link 105 being between two threshold levels/values, which may be user-designated.

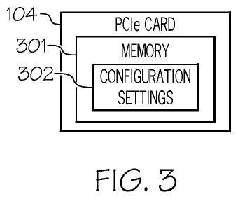

In one embodiment, such modes of operation of PCIe card 104 are established by selecting the appropriate configuration settings of PCIe card 104. In one embodiment, such configuration settings are stored in memory (e.g., SEEPROM (Serial Electrically Erasable Programmable Read-Only Memory)) of PCIe card 104, such as shown in FIG. 3.

FIG. 3 illustrates the storage of the configuration settings in the memory (e.g., SEEPROM) of PCIe card 104 in accordance with an embodiment of the present disclosure.

Referring to FIG. 3, PCIe card 104 includes a memory 301 (e.g., SEEPROM) configured to store configuration settings 302. Examples of memory 301 can include, but are not limited to, serial electrically erasable programmable read-only memory, dynamic random-access memory, synchronous dynamic random-access memory, static random-access memory, etc.

Configuration settings 302, as used herein, refer to a set of parameters that can be changed that affect the functionality of PCIe card 104. For example, such parameters may be modified by PCIe controller 203 to implement a different mode of operation for PCIe card 104, such as to operate in a mode of operation that provides higher bandwidth, and hence use more power, than another mode of operation. In another example, such parameters may be modified by PCIe controller 203 to enable PCIe card 104 to operate in a mode of operation that provides lower bandwidth, and hence use less power, than a different mode of operation.

In an alternative embodiment, configuration settings 302 are stored in a storage device of computing device 101 thereby alleviating the requirement to store the configuration settings on every PCIe card 104.

Returning to FIG. 2, in conjunction with FIGS. 1 and 3, in one embodiment, upon determining if the predicted bandwidth utilization of PCIe link 105 exceeds a threshold value and thereby determining which mode of operation PCIe card 104 should be operating, such as at a future time, PCIe controller 203 makes a determination at that future time as to whether the operation mode of PCIe card 104 at the future time is different than the mode of operation PCIe card 104 should be operating. For example, if the predicted bandwidth of PCIe link 105 (e.g., PCIe link 105A) exceeds a threshold value, then PCIe controller 203 determines that PCIe card 104 should be operating at the future time in a first mode of operation (e.g., PCIe 6.0), such as a mode of operation that provides higher bandwidth and uses more power. In such a scenario, PCIe controller 203 determines if PCIe card 104 is operating in the first mode of operation at the time the bandwidth utilization of PCIe link 105 involving PCIe card 104 is predicted to exceed the threshold value. For instance, PCIe controller 203 may make such a determination at the moment in time when the bandwidth utilization of PCIe link 105 involving PCIe card 104 is predicted to exceed the threshold value.

In another example, if the predicted bandwidth of PCIe link 105 (e.g., PCIe link 105A) does not exceed the threshold value, then PCIe controller 203 determines that PCIe card 104 should be operating in a second mode of operation (e.g., PCIe 4.0), such as a mode of operation that provides lower bandwidth and uses less power. In such a scenario, PCIe controller 203 determines if PCIe card 104 is operating in the second mode of operation at the time the bandwidth utilization of PCIe link 105 involving PCIe card 104 is predicted to not exceed the threshold value. For instance, PCIe controller 203 may make such a determination at the moment in time when the bandwidth utilization of PCIe link 105 involving PCIe card 104 is predicted to not exceed the threshold value.

If PCIe card 104 is operating in a different mode of operation, such as a second mode of operation (e.g., PCIe 4.0), than the mode of operation that PCIe card 104 should be operating (e.g., PCIe 6.0) at the time the bandwidth utilization of PCIe link 105 (e.g., PCIe link 105A) involving PCIe card 104 is predicted to exceed or not exceed the threshold value, then PCIe controller 203 determines whether there is currently traffic on PCIe link 105 (e.g., PCIe link 105A) prior to switching the mode of operation of PCIe card 104 to operate in the mode of operation PCIe card 104 should be operating at the time the bandwidth utilization of PCIe link 105 (e.g., PCIe link 105A) involving PCIe card 104 is predicted to exceed or not exceed the threshold value.

In one embodiment, traffic on PCIe link 105 (e.g., PCIe link 105A) is determined by traffic flow engine 204 of computing device 101. In one embodiment, traffic flow engine 204 determines the current traffic flow on PCIe link 105 (e.g., PCIe link 105A) by utilizing a CATC® trace. In one embodiment, CATC® trace combines both the upstream and downstream data paths into a single trace even though they are parallel paths that can both be active simultaneously. In one embodiment, CATC® trace contains several fields, such as a field to indicate the packet type (e.g., TLP (Transaction Layer Packet), DLLP (Data Link Layer Packet), etc.), packet payload, delay between a packet and the next packet on its data path, etc.

In one embodiment, traffic flow engine 204 determines the current traffic flow on PCIe link 105 (e.g., PCIe link 105A) using various software tools, which can include, but are not limited to, LogicMonitor®, Intel® VTune™ Profiler, ManageEngine® NetFlow® Analyzer, SolarWinds® Network Performance Monitor, Paessler® Network Monitor, etc.

In response to determining that there is no traffic currently flowing on PCIe link 105 associated with the PCIe card 104 whose mode of operation needs to be switched, such as from a second mode of operation to a first mode of operation, PCIe controller 203 proceeds with selecting the configuration setting (e.g., configuration setting 302) to switch the mode of operation of PCIe card 104, such as selecting the configuration setting (e.g., configuration setting 302) to use the first mode of operation (e.g., PCIe 6.0) corresponding to a mode of operation that provides higher bandwidth and uses more power. In another example, if the mode of operation of PCIe card 104 needs to be switched from a first mode of operation to second mode of operation, PCIe controller 203 proceeds with selecting the configuration setting (e.g., configuration setting 302) to switch the mode of operation of PCIe card 104, such as selecting the configuration setting (e.g., configuration setting 302) of PCIe card 104 to implement the second mode of operation (e.g., PCIe 4.0) corresponding to a mode of operation that provides lower bandwidth and uses less power.

If there is traffic currently flowing on PCIe link 105 associated with PCIe card 104 whose mode of operation needs to be switched, such as from a second mode of operation to a first mode of operation, then PCIe controller 203 determines if the traffic can be routed temporally to a different PCIe link 105, such as a PCIe link 105 that is currently free of traffic.

In one embodiment, PCIe controller 203 determines if there is currently a different PCIe link 105 (e.g., PCIe link 105B) that is not exhibiting traffic. In one embodiment, PCIe controller 203 instructs traffic flow engine 204 to determine the current traffic flow on other PCIe links 105 (e.g., PCIe links 105B, 105C) to determine if there is currently a different PCIe link 105 (e.g., PCIe link 105B) that is not exhibiting traffic. Traffic flow engine 204 makes such a determination using various software tools, which can include, but are not limited to, LogicMonitor®, Intel® VTune™ Profiler, ManageEngine® NetFlow® Analyzer, SolarWinds® Network Performance Monitor, Paessler® Network Monitor, etc.

If traffic can be routed temporally to a different PCIe link 105 (e.g., PCIe link 105B), then PCIe controller 203 temporally routes the traffic on PCIe link 105 (e.g., PCIe link 105A), involving PCIe card 104 (e.g., PCIe card 104A) whose mode of operation needs to be switched, to such a different PCIe link 105 (e.g., PCIe link 105B). Afterwards, PCIe controller 203 selects the configuration setting (e.g., configuration setting 302) to switch the mode of operation of PCIe card 104, such as selecting the configuration setting (e.g., configuration setting 302) of PCIe card 104 to implement the first mode of operation (e.g., PCIe 6.0) corresponding to a mode of operation that provides higher bandwidth and uses more power. In another example, PCIe controller 203 selects the configuration setting (e.g., configuration setting 302) of PCIe card 104 to implement the second mode of operation (e.g., PCIe 4.0) corresponding to a mode of operation that provides lower bandwidth and uses less power.

If, however, traffic cannot be temporarily routed to a different PCIe link 105 (e.g., PCIe link 105B), then PCIe controller 203 waits for the data transmission on PCIe link 105 (e.g., PCIe link 105A), involving PCIe card 104 (e.g., PCIe card 104A) whose mode of operation needs to be switched, to end. Afterwards, PCIe controller 203 selects the configuration setting (e.g., configuration setting 302) of PCIe card 104 to implement the first mode of operation (e.g., PCIe 6.0) corresponding to a mode of operation that provides higher bandwidth and uses more power. In another example, PCIe controller 203 selects the configuration setting (e.g., configuration setting 302) of PCIe card 104 to implement the second mode of operation (e.g., PCIe 4.0) corresponding to a mode of operation that provides lower bandwidth and uses less power.

In this manner, the bandwidth utilization of PCIe link 105 is maximized and the amount of power wasted is minimized.

In one embodiment, upon selecting configuration setting 302 of PCIe card 104 to switch the mode of operation of PCIe card 104, the mode of operation is switched by resetting PCIe link 105 (PCIe link 105 involving PCIe card 104 whose mode of operation is switched) and the PCIe slot followed by implementing the new mode of operation of PCIe card 104.

In one embodiment, traffic consisting of workloads or transactions are designated to be directed to particular logical partitions of hardware via PCIe link 105 based on the mode of operation of PCIe card 104. For example, in one embodiment, workloads involving marketing websites or analytic platforms may be designated to be directed to a first set of logical partitions of hardware in response to PCIe card 104 operating in a first mode of operation (e.g., high bandwidth mode of operation) and directed to a second set of logical partitions of hardware in response to PCIe card 104 operating in a second mode of operation (e.g., low bandwidth mode of operation).

In one embodiment, a data structure (e.g., table) contains information pertaining to the set of logical partitions of hardware to be utilized for designated workloads or transactions based on the mode of operation of PCIe card 104. In one embodiment, PCIe controller 203 determines the type of workloads or transactions based on their classifications, such as classifications that were assigned to such workloads or transactions using the workload management (WLM) workload classification rules promulgated by MVS™ (multiple virtual storage) Workload Management. Upon determining the type of workloads or transactions, such a classification is associated with particular logical partitions of hardware based on the mode of operation of PCIe card 104 as indicated in the data structure (e.g., table) discussed above. In one embodiment, such a data structure resides within a storage device of computing device 101. In one embodiment, such a data structure is populated by an expert.

A further description of these and other features is provided below in connection with the discussion of the method for maximizing bandwidth utilization of PCIe links.

Prior to the discussion of the method for maximizing bandwidth utilization of PCIe links, a description of the hardware configuration of computing device 101 (FIG. 1) is provided below in connection with FIG. 4.

Referring now to FIG. 4, in conjunction with FIG. 1, FIG. 4 illustrates an embodiment of the present disclosure of the hardware configuration of computing device 101 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code 401 involved in performing the inventive methods, such as maximizing bandwidth utilization of PCIe links. In addition to block 401, computing environment 400 includes, for example, computing device 101, network 102, such as a wide area network (WAN), end user device (EUD) 402, remote server 403, public cloud 404, and private cloud 405. In this embodiment, computing device 101 includes processor set 406 (including processing circuitry 407 and cache 408), communication fabric 409, volatile memory 410, persistent storage 411 (including operating system 412 and block 401, as identified above), peripheral device set 413 (including user interface (UI) device set 414, storage 415, and Internet of Things (IoT) sensor set 416), and network module 417. Remote server 403 includes remote database 418. Public cloud 404 includes gateway 419, cloud orchestration module 420, host physical machine set 421, virtual machine set 422, and container set 423.

Computing device 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 418. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computing device 101, to keep the presentation as simple as possible. Computing device 101 may be located in a cloud, even though it is not shown in a cloud in FIG. 4. On the other hand, computing device 101 is not required to be in a cloud except to any extent as may be affirmatively indicated.

Processor set 406 includes one, or more, computer processors of any type now known or to be developed in the future. Processing circuitry 407 may be distributed over multiple packages, for example, multiple, coordinated integrated circuit chips. Processing circuitry 407 may implement multiple processor threads and/or multiple processor cores. Cache 408 is memory that is located in the processor chip package(s) and is typically used for data or code that should be available for rapid access by the threads or cores running on processor set 406. Cache memories are typically organized into multiple levels depending upon relative proximity to the processing circuitry. Alternatively, some, or all, of the cache for the processor set may be located “off chip.” In some computing environments, processor set 406 may be designed for working with qubits and performing quantum computing.

Computer readable program instructions are typically loaded onto computing device 101 to cause a series of operational steps to be performed by processor set 406 of computing device 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 408 and the other storage media discussed below. The program instructions, and associated data, are accessed by processor set 406 to control and direct performance of the inventive methods. In computing environment 400, at least some of the instructions for performing the inventive methods may be stored in block 401 in persistent storage 411.

Communication fabric 409 is the signal conduction paths that allow the various components of computing device 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 410 is any type of volatile memory now known or to be developed in the future. Examples include dynamic type random access memory (RAM) or static type RAM. Typically, the volatile memory is characterized by random access, but this is not required unless affirmatively indicated. In computing device 101, the volatile memory 410 is located in a single package and is internal to computing device 101, but, alternatively or additionally, the volatile memory may be distributed over multiple packages and/or located externally with respect to computing device 101.

Persistent Storage 411 is any form of non-volatile storage for computers that is now known or to be developed in the future. The non-volatility of this storage means that the stored data is maintained regardless of whether power is being supplied to computing device 101 and/or directly to persistent storage 411. Persistent storage 411 may be a read only memory (ROM), but typically at least a portion of the persistent storage allows writing of data, deletion of data and re-writing of data. Some familiar forms of persistent storage include magnetic disks and solid state storage devices. Operating system 412 may take several forms, such as various known proprietary operating systems or open source Portable Operating System Interface type operating systems that employ a kernel. The code included in block 401 typically includes at least some of the computer code involved in performing the inventive methods.

Peripheral device set 413 includes the set of peripheral devices of computing device 101. Data communication connections between the peripheral devices and the other components of computing device 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 414 may include components such as a display screen, speaker, microphone, wearable devices (such as goggles and smart watches), keyboard, mouse, printer, touchpad, game controllers, and haptic devices. Storage 415 is external storage, such as an external hard drive, or insertable storage, such as an SD card. Storage 415 may be persistent and/or volatile. In some embodiments, storage 415 may take the form of a quantum computing storage device for storing data in the form of qubits. In embodiments where computing device 101 is required to have a large amount of storage (for example, where computing device 101 locally stores and manages a large database) then this storage may be provided by peripheral storage devices designed for storing very large amounts of data, such as a storage area network (SAN) that is shared by multiple, geographically distributed computers. IoT sensor set 416 is made up of sensors that can be used in Internet of Things applications. For example, one sensor may be a thermometer and another sensor may be a motion detector.

Network module 417 is the collection of computer software, hardware, and firmware that allows computing device 101 to communicate with other computers through WAN 102. Network module 417 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 417 are performed on the same physical hardware device. In other embodiments (for example, embodiments that utilize software-defined networking (SDN)), the control functions and the forwarding functions of network module 417 are performed on physically separate devices, such that the control functions manage several different network hardware devices. Computer readable program instructions for performing the inventive methods can typically be downloaded to computing device 101 from an external computer or external storage device through a network adapter card or network interface included in network module 417.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 402 is any computer system that is used and controlled by an end user (for example, a customer of an enterprise that operates computing device 101), and may take any of the forms discussed above in connection with computing device 101. EUD 402 typically receives helpful and useful data from the operations of computing device 101. For example, in a hypothetical case where computing device 101 is designed to provide a recommendation to an end user, this recommendation would typically be communicated from network module 417 of computing device 101 through WAN 102 to EUD 402. In this way, EUD 402 can display, or otherwise present, the recommendation to an end user. In some embodiments, EUD 402 may be a client device, such as thin client, heavy client, mainframe computer, desktop computer and so on.

Remote server 403 is any computer system that serves at least some data and/or functionality to computing device 101. Remote server 403 may be controlled and used by the same entity that operates computing device 101. Remote server 403 represents the machine(s) that collect and store helpful and useful data for use by other computers, such as computing device 101. For example, in a hypothetical case where computing device 101 is designed and programmed to provide a recommendation based on historical data, then this historical data may be provided to computing device 101 from remote database 418 of remote server 403.

Public cloud 404 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 404 is performed by the computer hardware and/or software of cloud orchestration module 420. The computing resources provided by public cloud 404 are typically implemented by virtual computing environments that run on various computers making up the computers of host physical machine set 421, which is the universe of physical computers in and/or available to public cloud 404. The virtual computing environments (VCEs) typically take the form of virtual machines from virtual machine set 422 and/or containers from container set 423. It is understood that these VCEs may be stored as images and may be transferred among and between the various physical machine hosts, either as images or after instantiation of the VCE. Cloud orchestration module 420 manages the transfer and storage of images, deploys new instantiations of VCEs and manages active instantiations of VCE deployments. Gateway 419 is the collection of computer software, hardware, and firmware that allows public cloud 404 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 405 is similar to public cloud 404, except that the computing resources are only available for use by a single enterprise. While private cloud 405 is depicted as being in communication with WAN 102 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 404 and private cloud 405 are both part of a larger hybrid cloud.

Block 401 further includes the software components discussed above in connection with FIGS. 2-3 to maximize the bandwidth utilization of PCIe links, such as PCIe links 105. In one embodiment, such components may be implemented in hardware. The functions discussed above performed by such components are not generic computer functions. As a result, computing device 101 is a particular machine that is the result of implementing specific, non-generic computer functions.

In one embodiment, the functionality of such software components of computing device 101, including the functionality for maximizing the bandwidth utilization of PCIe links, such as PCIe links 105, may be embodied in an application specific integrated circuit.

As stated above, the PCIe bus is a high-speed serial replacement of the older PCI/PCI-X bus. One of the key differences between the PCI Express bus and the older PCI is the bus topology. PCI uses a shared parallel bus architecture in which the PCI host and all devices share a common set of address, data, and control lines. In contrast, PCI Express is based on point-to-point topology, with separate serial links connecting every device to the root complex (host). Because of its shared bus topology, access to the older PCI bus is arbitrated (in the case of multiple masters), and limited to one master at a time, in a single direction. Furthermore, the older PCI clocking scheme limits the bus clock to the slowest peripheral on the bus (regardless of the devices involved in the bus transaction). In contrast, a PCIe bus link supports full-duplex communication between any two endpoints with no inherent limitation on concurrent access across multiple endpoints. PCIe devices, such as PCIe cards, communicate via a logical connection called an interconnect or a link. A link is a point-to-point communication channel between two PCI Express ports allowing both of them to send and receive ordinary PCI requests (configuration, I/O or memory read/write) and interrupts (INTx, MSI or MSI-X). At the physical level, a link is composed of one or more lanes. A lane is composed of two differential signaling pairs with one pair for receiving data and the other for transmitting. Thus, each lane is composed of four wires or signal traces. Conceptually, each lane is used as a full-duplex byte stream, transporting data packets in eight-bit “byte” format simultaneously in both directions between endpoints of a link. Physical PCI Express links may contain 1, 4, 8, or 16 lanes. As discussed above, PCIe cards communicate with a logical connection called an interconnect or link. A PCIe card is a network adapter with a PCIe interface. PCIe cards are designed to fit into PCIe-based slots, such as slots in the motherboard of devices, such as a host, server, network switch, etc. A PCIe card implements the PCIe protocol. As a result, after inserting a PCIe card, a logical connection (“link”) will be formed between the PCIe card and the motherboard enabling a point-to-point communication channel between the two PCIe ports and allowing both of them to send and receive ordinary PCI requests and interrupts. There are various generations or versions of PCIe, such as PCIe 1.0, PCIe 2.0, PCIe 3.0, PCIe 4.0, PCIe 5.0, and PCIe 6.0. Higher PCIe versions or generations utilize more power than previous generations, which have slower signaling rates. Each PCIe version supports roughly double the bandwidth of the previous version of PCIe. As a result, during times of low bandwidth utilization, such higher versions or generations of PCIe have available bandwidth which is not being used. During such situations, power is being wasted. Unfortunately, there is not currently a means for limiting or preventing such wasted power.

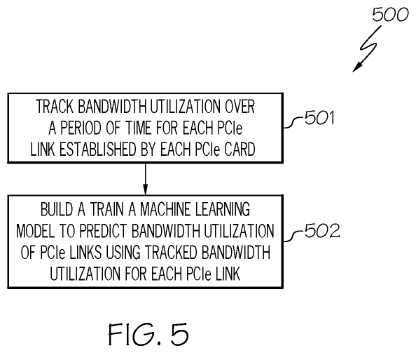

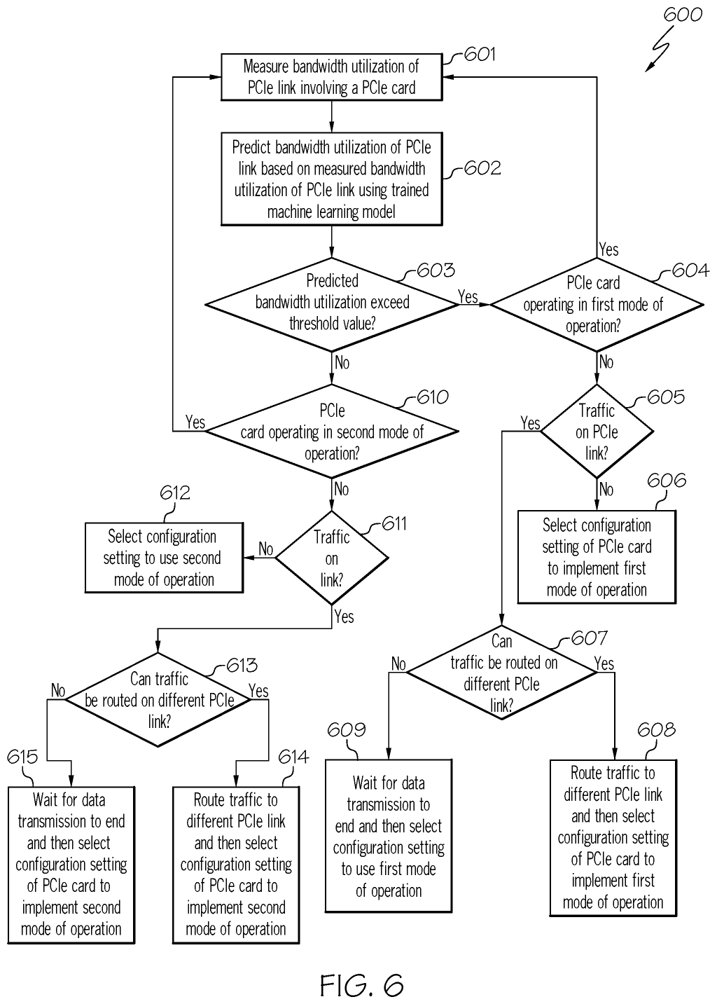

The embodiments of the present disclosure provide a means for limiting or preventing such wasted power by switching modes of operation of the PCIe card such that the PCIe card switches to a mode of operation that uses less power during a period of predicted low bandwidth utilization and switches to a mode of operation that uses more power during a period of predicted high bandwidth utilization as discussed below in connection with FIGS. 5-6. FIG. 5 is a flowchart of a method for training a machine learning model to predict the bandwidth utilization of PCIe links (e.g., PCIe links 105). FIG. 6 is a flowchart of a method for maximizing the bandwidth utilization of PCIe links (e.g., PCIe links 105).

As stated above, FIG. 5 is a flowchart of a method 500 for training a machine learning model to predict the bandwidth utilization of PCIe links (e.g., PCIe links 105) in accordance with an embodiment of the present disclosure.

Referring to FIG. 5, in conjunction with FIGS. 1-4, in step 501, measurement engine 201 of computing device 101 tracks the bandwidth utilization over a period of time (e.g., a week, a month) for each PCIe link 105 established by each PCIe card 104.

As discussed above, bandwidth utilization, as used herein, refers to the rate at which data can flow through PCIe link 105. In one embodiment, such a bandwidth utilization is provided in terms of a percentage of a link transfer rate, such as 70% of the link transfer rate. In one embodiment, such a bandwidth utilization is provided in terms of bytes per second (e.g., 64 GB/s). Measurement engine 201 may utilize various tools for tracking the bandwidth utilization for each PCIe link 105 including, but are not limited to, Intel® Performance Counter Monitor, 3DMark®, Libre Hardware Monitor, etc.

In one embodiment, by measurement engine 201 tracking the bandwidth utilization of PCIe link 105 over a period of time, such information may be used to train a machine learning model to predict the bandwidth utilization of PCIe link 105, such as at a particular future moment in time, based on a currently measured bandwidth utilization of PCIe link 105 as discussed further below.

In step 502, machine learning engine 202 of computing device 101 builds and trains a machine learning model to predict the bandwidth utilization of PCIe links 105 at a future moment in time using the tracked bandwidth utilization for each PCIe link 105.

As stated above, such a prediction for the bandwidth utilization of PCIe link 105 (e.g., PCIe link 105A) is provided by the machine learning model based on inputting to the trained machine learning model a currently measured bandwidth utilization of PCIe link 105 (e.g., PCIe link 105A).

In one embodiment, the machine learning model is trained to predict the bandwidth utilization of PCIe link 105 at a future moment in time based on a sample data set that includes the tracked bandwidth utilization of PCIe link 105 over a period of time. Such a sample data set may be stored in a data structure (e.g., table) residing within the storage device (e.g., storage device 411, 415) of computing device 101.

Furthermore, in one embodiment, the sample data set discussed above is referred to herein as the “training data,” which is used by a machine learning algorithm to make predictions as to the bandwidth utilization of PCIe link 105. The algorithm iteratively makes predictions on the training data as to the predicted bandwidth utilization of PCIe link 105 until the predictions achieve the desired accuracy as determined by an expert. Examples of such learning algorithms include nearest neighbor, Naïve Bayes, decision trees, linear regression, support vector machines, and neural networks.

After such a machine learning model is trained, it may be utilized by PCIe controller 203 of computing device 101 to predict the bandwidth utilization of PCIe link 105 (e.g., PCIe link 105A) based on the measured bandwidth utilization, such as the currently measured bandwidth utilization, of PCIe link 105 (e.g., PCIe link 105A) using the trained machine learning model as discussed below in connection with FIG. 6.

FIG. 6 is a flowchart of a method 600 for maximizing the bandwidth utilization of PCIe links (e.g., PCIe links 105) in accordance with an embodiment of the present disclosure.

Referring to FIG. 6, in conjunction with FIGS. 1-5, in step 601, measurement engine 201 of computing device 101 measures the bandwidth utilization of PCIe link 105 (e.g., PCIe link 105A) involving a PCIe card 104 (e.g., PCIe card 104A) at a current moment in time.

As discussed above, in one embodiment, such a bandwidth utilization is provided in terms of a percentage of a link transfer rate, such as 70% of the link transfer rate. In one embodiment, such a bandwidth utilization is provided in terms of bytes per second (e.g., 64 GB/s). Measurement engine 201 may utilize various tools for measuring the bandwidth utilization of PCIe link 105 (e.g., PCIe link 105A) at a current moment in time including, but are not limited to, Intel® Performance Counter Monitor, 3DMark®, Libre Hardware Monitor, etc.

In step 602, PCIe controller 203 of computing device 101 predicts the bandwidth utilization of PCIe link 105 (e.g., PCIe link 105A) at a future time based on the measured bandwidth utilization of PCIe link 105, such as the currently measured bandwidth utilization of PCIe link 105 (e.g., PCIe link 105A), using the trained machine learning model. In one embodiment, such a measured bandwidth utilization, such as the currently measured bandwidth utilization of PCIe link 105 (e.g., PCIe link 105A), is inputted into the trained machine learning model, which outputs a predicted bandwidth utilization of PCIe link 105 (e.g., PCIe link 105A) at a future time (e.g., next hour), which may be user-designated.

In step 603, PCIe controller 203 of computing device 101 determines if the predicted bandwidth utilization of PCIe link 105 at a future time exceeds a threshold value, which may be user-designated. In one embodiment, such a threshold value may be in terms of a percentage of a link transfer rate, such as 70% of the link transfer rate. In one embodiment, such a threshold value may be in terms of bytes per second (e.g., 64 GB/s).

As stated above, in one embodiment, PCIe controller 203 determines if the predicted bandwidth utilization of PCIe link 105 at a future time exceeds the threshold value in order to determine which mode of operation should be utilized by PCIe card 104 forming such a PCIe link 105. In one embodiment, PCIe card 104 may operate in two different modes of operation, such as a high bandwidth mode of operation and a low bandwidth mode of operation. A high bandwidth mode of operation, as used herein, refers to a mode of operation of PCIe card 104 that involves a higher version or generation of PCIe that utilizes more bandwidth. For example, such a higher version or generation of PCIe, such as PCIe 6.0, may correspond to a bandwidth utilization rate of 128 GB/s. A low bandwidth mode of operation, as used herein, refers to a mode of operation of PCIe card 104 that involves a lower version or generation of PCIe that utilizes less bandwidth. For example, such a lower version or generation of PCIe, such as PCIe 4.0, may correspond to a bandwidth utilization rate of 32 GB/s. While the following discusses two modes of operation, it is noted that the principles of the present disclosure may utilize any number of modes of operation, where the utilization of each mode of operation is determined based on a predicted bandwidth utilization of PCIe link 105 being between two threshold levels/values, which may be user-designated.

In one embodiment, such modes of operation of PCIe card 104 are established by selecting the appropriate configuration settings of PCIe card 104. In one embodiment, such configuration settings are stored in memory (e.g., SEEPROM (Serial Electrically Erasable Programmable Read-Only Memory)) of PCIe card 104, such as shown in FIG. 3.

Referring to FIG. 3, PCIe card 104 includes a memory 301 (e.g., SEEPROM) configured to store configuration settings 302. Examples of memory 301 can include, but are not limited to, serial electrically erasable programmable read-only memory, dynamic random-access memory, synchronous dynamic random-access memory, static random-access memory, etc.

Configuration settings 302, as used herein, refer to a set of parameters that can be changed that affect the functionality of PCIe card 104. For example, such parameters may be modified by PCIe controller 203 to implement a different mode of operation for PCIe card 104, such as to operate in a mode of operation that provides higher bandwidth, and hence use more power, than another mode of operation. In another example, such parameters may be modified by PCIe controller 203 to enable PCIe card 104 to operate in a mode of operation that provides lower bandwidth, and hence use less power, than a different mode of operation.

In an alternative embodiment, configuration settings 302 are stored in a storage device (e.g., storage device 411, 415) of computing device 101 thereby alleviating the requirement to store the configuration settings on every PCIe card 104.

If the predicted bandwidth utilization of PCIe link 105 at a future time exceeds a threshold value, then PCIe card 104 should be operating in a first mode of operation (e.g., PCIe 6.0), such as a mode of operation that provides higher bandwidth and uses more power. In such a scenario, in step 604, PCIe controller 203 of computing device 101 determines if the mode of operation of PCIe card 104 at the future time is different than the mode of operation PCIe card 104 should be operating (e.g., first mode of operation). For example, if the predicted bandwidth of PCIe link 105 (e.g., PCIe link 105A) exceeds a threshold value, then PCIe controller 203 determines if PCIe card 104 is operating in the first mode of operation at the time the bandwidth utilization of PCIe link 105 involving PCIe card 104 is predicted to exceed the threshold value. For instance, PCIe controller 203 may make such a determination at the moment in time when the bandwidth utilization of PCIe link 105 involving PCIe card 104 is predicted to exceed the threshold value.

If PCIe card 104 is operating in the first mode of operation at the time the bandwidth utilization of PCIe link 105 involving PCIe card 104 is predicted to exceed the threshold value, then PCIe card 104 continues to operate in the first mode of operation and measurement engine 201 of computing device 101 measures the bandwidth utilization of the same or different PCIe link 105 (e.g., PCIe link 105A) involving a PCIe card 104 (e.g., PCIe card 104A) at a current moment in time in step 601.

If PCIe card 104 is not operating in the first mode of operation (e.g., operating in the second mode of operation) at the time the bandwidth utilization of PCIe link 105 involving PCIe card 104 is predicted to exceed the threshold value, then, in step 605, PCIe controller 203 of computing device 101 determines whether there is currently traffic on PCIe link 105 (e.g., PCIe link 105A whose predicted bandwidth utilization exceeds the threshold value) prior to switching the mode of operation of PCIe card 104 to operate in the first mode of operation at the time the bandwidth utilization of PCIe link 105 (e.g., PCIe link 105A) involving PCIe card 104 is predicted to exceed the threshold value.

As discussed above, in one embodiment, traffic on PCIe link 105 (e.g., PCIe link 105A) is determined by traffic flow engine 204 of computing device 101. In one embodiment, traffic flow engine 204 determines the current traffic flow on PCIe link 105 (e.g., PCIe link 105A) by utilizing a CATC® trace. In one embodiment, CATC® trace combines both the upstream and downstream data paths into a single trace even though they are parallel paths that can both be active simultaneously. In one embodiment, CATC® trace contains several fields, such as a field to indicate the packet type (e.g., TLP (Transaction Layer Packet), DLLP (Data Link Layer Packet), etc.), packet payload, delay between a packet and the next packet on its data path, etc.

In one embodiment, traffic flow engine 204 determines the current traffic flow on PCIe link 105 (e.g., PCIe link 105A) using various software tools, which can include, but are not limited to, LogicMonitor®, Intel® VTune™ Profiler, ManageEngine® NetFlow® Analyzer, SolarWinds® Network Performance Monitor, Paessler® Network Monitor, etc.

If there is not currently traffic on PCIe link 105 (e.g., PCIe link 105A whose predicted bandwidth utilization exceeds the threshold value) prior to switching the mode of operation of PCIe card 104 to operate in the first mode of operation, then, in step 606, PCIe controller 203 of computing device 101 selects the configuration setting (e.g., configuration setting 302) of PCIe card 104 to implement the first mode of operation (e.g., PCIe 6.0) corresponding to a mode of operation that provides higher bandwidth and uses more power.

If, however, there is currently traffic on PCIe link 105 (e.g., PCIe link 105A whose predicted bandwidth utilization exceeds the threshold value) prior to switching the mode of operation of PCIe card 104 to operate in the first mode of operation, then, in step 607, PCIe controller 203 of computing device 101 determines if the traffic can be temporally routed to a different PCIe link 105, such as a PCIe link 105 that is currently free of traffic.

As stated above, in one embodiment, PCIe controller 203 determines if there is currently a different PCIe link 105 (e.g., PCIe link 105B) that is not exhibiting traffic. In one embodiment, PCIe controller 203 instructs traffic flow engine 204 to determine the current traffic flow on other PCIe links 105 (e.g., PCIe links 105B, 105C) to determine if there is currently a different PCIe link 105 (e.g., PCIe link 105B) that is not exhibiting traffic. Traffic flow engine 204 makes such a determination using various software tools, which can include, but are not limited to, LogicMonitor®, Intel® VTune™ Profiler, ManageEngine® NetFlow® Analyzer, SolarWinds® Network Performance Monitor, Paessler® Network Monitor, etc.

If traffic can be temporally routed to a different PCIe link 105 (e.g., PCIe link 105B), then, in step 608, PCIe controller 203 of computing device 101 routes the traffic to the different PCIe link 105 (e.g., PCIe link 105B). Afterwards, PCIe controller 203 selects the configuration setting (e.g., configuration setting 302) of PCIe card 104 to implement the first mode of operation (e.g., PCIe 6.0) corresponding to a mode of operation that provides higher bandwidth and uses more power.

If, however, traffic cannot be temporarily routed to a different PCIe link 105 (e.g., PCIe link 105B), then, in step 609, PCIe controller 203 of computing device 101 waits for the data transmission on PCIe link 105 (e.g., PCIe link 105A), involving the PCIe card 104 (e.g., PCIe card 104A) whose mode of operation needs to be switched, to end. Afterwards, PCIe controller 203 selects the configuration setting (e.g., configuration setting 302) of PCIe card 104 to implement the first mode of operation (e.g., PCIe 6.0) corresponding to a mode of operation that provides higher bandwidth and uses more power.

In this manner, the bandwidth utilization of PCIe link 105 is maximized and the amount of power wasted is minimized.

Returning to step 603, if, however, the predicted bandwidth utilization of PCIe link 105 at a future time does not exceed a threshold value, which may be user-designated, then PCIe card 104 should be operating in a second mode of operation (e.g., PCIe 4.0), such as a mode of operation that provides lower bandwidth and uses less power. In such a scenario, in step 610, PCIe controller 203 of computing device 101 determines if the mode of operation of PCIe card 104 at the future time is different than the mode of operation PCIe card 104 should be operating (e.g., second mode of operation). For example, if the predicted bandwidth of PCIe link 105 (e.g., PCIe link 105A) does not exceeds a threshold value, then PCIe controller 203 determines if PCIe card 104 is operating in the second mode of operation at the time the bandwidth utilization of PCIe link 105 involving PCIe card 104 is predicted to not exceed the threshold value. For instance, PCIe controller 203 may make such a determination at the moment in time when the bandwidth utilization of PCIe link 105 involving PCIe card 104 is predicted to not exceed the threshold value.

If PCIe card 104 is operating in the second mode of operation at the time the bandwidth utilization of PCIe link 105 involving PCIe card 104 is predicted to not exceed the threshold value, then PCIe card 104 continues to operate in the second mode of operation and measurement engine 201 of computing device 101 measures the bandwidth utilization of the same or different PCIe link 105 (e.g., PCIe link 105A) involving a PCIe card 104 (e.g., PCIe card 104A) at a current moment in time in step 601.

If PCIe card 104 is not operating in the second mode of operation (e.g., operating in the first mode of operation) at the time the bandwidth utilization of PCIe link 105 involving PCIe card 104 is predicted to not exceed the threshold value, then, in step 611, PCIe controller 203 of computing device 101 determines whether there is currently traffic on PCIe link 105 (e.g., PCIe link 105A whose predicted bandwidth utilization does not exceed the threshold value) prior to switching the mode of operation of PCIe card 104 to operate in the second mode of operation at the time the bandwidth utilization of PCIe link 105 (e.g., PCIe link 105A) involving PCIe card 104 is predicted to not exceed the threshold value.

As discussed above, in one embodiment, traffic on PCIe link 105 (e.g., PCIe link 105A) is determined by traffic flow engine 204 of computing device 101. In one embodiment, traffic flow engine 204 determines the current traffic flow on PCIe link 105 (e.g., PCIe link 105A) by utilizing a CATC® trace. In one embodiment, CATC® trace combines both the upstream and downstream data paths into a single trace even though they are parallel paths that can both be active simultaneously. In one embodiment, CATC® trace contains several fields, such as a field to indicate the packet type (e.g., TLP (Transaction Layer Packet), DLLP (Data Link Layer Packet), etc.), packet payload, delay between a packet and the next packet on its data path, etc.

In one embodiment, traffic flow engine 204 determines the current traffic flow on PCIe link 105 (e.g., PCIe link 105A) using various software tools, which can include, but are not limited to, LogicMonitor®, Intel® VTune™ P Profiler, ManageEngine® NetFlow® Analyzer, SolarWinds® Network Performance Monitor, Paessler® Network Monitor, etc.

If there is not currently traffic on PCIe link 105 (e.g., PCIe link 105A whose predicted bandwidth utilization does not exceed the threshold value) prior to switching the mode of operation of PCIe card 104 to operate in the second mode of operation, then, in step 612, PCIe controller 203 of computing device 101 selects the configuration setting (e.g., configuration setting 302) of PCIe card 104 to implement the second mode of operation (e.g., PCIe 4.0) corresponding to a mode of operation that provides lower bandwidth and uses less power.

If, however, there is currently traffic on PCIe link 105 (e.g., PCIe link 105A whose predicted bandwidth utilization does not exceed the threshold value) prior to switching the mode of operation of PCIe card 104 to operate in the second mode of operation, then, in step 613, PCIe controller 203 of computing device 101 determines if the traffic can be temporally routed to a different PCIe link 105, such as a PCIe link 105 that is currently free of traffic.

As stated above, in one embodiment, PCIe controller 203 determines if there is currently a different PCIe link 105 (e.g., PCIe link 105B) that is not exhibiting traffic. In one embodiment, PCIe controller 203 instructs traffic flow engine 204 to determine the current traffic flow on other PCIe links 105 (e.g., PCIe links 105B, 105C) to determine if there is currently a different PCIe link 105 (e.g., PCIe link 105B) that is not exhibiting traffic. Traffic flow engine 204 makes such a determination using various software tools, which can include, but are not limited to, LogicMonitor®, Intel® VTune™ Profiler, ManageEngine® NetFlow® Analyzer, SolarWinds® Network Performance Monitor, Paessler® Network Monitor, etc.

If traffic can be temporally routed to a different PCIe link 105 (e.g., PCIe link 105B), then, in step 614, PCIe controller 203 of computing device 101 routes the traffic to the different PCIe link 105 (e.g., PCIe link 105B). Afterwards, PCIe controller 203 selects the configuration setting (e.g., configuration setting 302) of PCIe card 104 to implement the second mode of operation (e.g., PCIe 4.0) corresponding to a mode of operation that provides lower bandwidth and uses less power.

If, however, traffic cannot be temporarily routed to a different PCIe link 105 (e.g., PCIe link 105B), then, in step 615, PCIe controller 203 of computing device 101 waits for the data transmission on PCIe link 105 (e.g., PCIe link 105A), involving the PCIe card 104 (e.g., PCIe card 104A) whose mode of operation needs to be switched, to end. Afterwards, PCIe controller 203 selects the configuration setting (e.g., configuration setting 302) of PCIe card 104 to implement the second mode of operation (e.g., PCIe 4.0) corresponding to a mode of operation that provides lower bandwidth and uses less power.

In this manner, the bandwidth utilization of PCIe link 105 is maximized and the amount of power wasted is minimized.

In one embodiment, in connection with selecting configuration setting 302 of PCIe card 104 to switch the mode of operation of PCIe card 104 as discussed above, the mode of operation is switched by resetting PCIe link 105 (PCIe link 105 involving PCIe card 104 whose mode of operation is switched) and the PCIe slot followed by implementing the new mode of operation of PCIe card 104.

In one embodiment, traffic consisting of workloads or transactions are designated to be directed to particular logical partitions of hardware via PCIe link 105 based on the mode of operation of PCIe card 104. For example, in one embodiment, workloads involving marketing websites or analytic platforms may be designated to be directed to a first set of logical partitions of hardware in response to PCIe card 104 operating in a first mode of operation (e.g., high bandwidth mode of operation) and directed to a second set of logical partitions of hardware in response to PCIe card 104 operating in a second mode of operation (e.g., low bandwidth mode of operation).

In one embodiment, a data structure (e.g., table) contains information pertaining to the set of logical partitions of hardware to be utilized for designated workloads or transactions based on the mode of operation of PCIe card 104. In one embodiment, PCIe controller 203 determines the type of workloads or transactions based on their classifications, such as classifications that were assigned to such workloads or transactions using the workload management (WLM) workload classification rules promulgated by MVS™ (multiple virtual storage) Workload Management. Upon determining the type of workloads or transactions, such a classification is associated with particular logical partitions of hardware based on the mode of operation of PCIe card 104 as indicated in the data structure (e.g., table) discussed above. In one embodiment, such a data structure resides within a storage device (e.g., storage device 411, 415) of computing device 101. In one embodiment, such a data structure is populated by an expert.

As a result of the foregoing, the principles of the present disclosure provide a means for limiting or preventing wasted power by switching modes of operation of the PCIe card such that the PCIe card switches to a mode of operation that uses less power during a period of predicted low bandwidth utilization of the PCIe link involving the PCIe card and switches to a mode of operation that uses more power during a period of predicted high bandwidth utilization of the PCIe link involving the PCIe card.

Furthermore, the principles of the present disclosure improve the technology or technical field involving Peripheral Component Interconnect Express (PCIe).

As discussed above, power supply systems may include a power module which provides the physical containment for several power components, such as switching regulators (e.g., DCDC switching regulators) and low-dropout (LDO) regulators. A switching regulator, such as a DCDC switching regulator, converts input direct current (DC) voltage to the desired direct current (DC) voltage. A LDO regulator is a DC linear voltage regulator that regulates the output voltage even when the input voltage is very close to the output voltage. Multiple regulators, such as switching regulators and LDO regulators, may be placed close to the processor chips or modules in order to meet the processor's requirement (e.g., low noise margin, high rush current, etc.) for point of load (POL). Point of load (POL) power supplies solve the challenge of high peak current demands and low noise margins required by high-performance semiconductors, such as microcontrollers or ASICs, by placing individual power supply regulators (linear or DCDC) close to their point of use. In order to implement a large current power supply system to supply power to a high-power multi-voltage system, the power module of the power supply system needs to utilize multiple regulators, such as the regulators discussed above, in order to implement POL for power distribution, save space for multiple power supplies and enable system portability. In certain situations, the power module of the power supply system needs to handle a surge of current (referred to herein as the “rush current”) due to a sudden increase in operation load, such as a sudden increase in the load exhibited by the high-power multi-voltage system. Such a surge of current may not be able to be handled by only the power module. For example, the de-coupling capacitor (capacitor used to decouple one part of a circuit from another) may not be able to maintain the correct voltage level to power the load. Furthermore, rush current may cause a malfunction in the power module, such as with the switching regulators (e.g., DCDC switching regulators) due to the saturation of the inductors or the destruction of the power switches. Furthermore, the malfunction of the switching regulators (e.g., DCDC switching regulators) may then cause operation problems for the LDO regulators due to having their input voltage and current supplied by such switching regulators. Unfortunately, there is not currently a means for effectively handling such surges of current (rush currents) by the power module due to a sudden increase in operation load.

Embodiments of the present disclosure improve such technology by measuring the bandwidth utilization of a PCIe link involving a PCIe card. In one embodiment, such a bandwidth utilization is provided in terms of a percentage of a link transfer rate, such as 70% of the link transfer rate. In one embodiment, such a bandwidth utilization is provided in terms of bytes per second (e.g., 64 GB/s). A bandwidth utilization of the PCIe link at a future time is predicted based on the measured bandwidth utilization of the PCIe link using a machine learning model trained to predict bandwidth utilization of PCIe links. If the predicted bandwidth utilization of the PCIe link exceeds a threshold value, then the mode of operation of the PCIe card is switched to implement a first mode of operation (e.g., a higher version or generation of PCIe) that utilizes more bandwidth if not implementing the first mode of operation at the future time. If the predicted bandwidth utilization of the PCIe link does not exceed a threshold value, then the mode of operation of the PCIe card is switched to implement a second mode of operation (e.g., a lower version or generation of PCIe) that utilizes less bandwidth if not implementing the second mode of operation at the future time. In this manner, the bandwidth utilization of the PCIe link is maximized and the amount of power wasted is minimized. Furthermore, in this manner, there is an improvement in the technical field involving Peripheral Component Interconnect Express (PCIe).

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for maximizing bandwidth utilization of Peripheral Component Interconnect Express (PCIe) links, the method comprising:
measuring a bandwidth utilization of a PCIe link involving a PCIe card;
predicating a bandwidth utilization of said PCIe link based on said measured bandwidth utilization of said PCIe link using a machine learning model trained to predict bandwidth 5 utilizations of PCIe links; and
switching a mode of operation of said PCIe card based on said predicted bandwidth utilization of said PCIe link.

2. The method as recited in claim 1 further comprising:
selecting a configuration setting of said PCIe card to implement a first mode of operation in response to said predicted bandwidth utilization of said PCIe link exceeding a threshold value, wherein said first mode of operation is a later version of PCIe than a second mode of operation.

3. The method as recited in claim 1 further comprising:
selecting a configuration setting of said PCIe card to implement a second mode of operation in response to said predicted bandwidth utilization of said PCIe link not exceeding a threshold value, wherein said second mode of operation is an earlier version of PCIe than a first mode of operation.

4. The method as recited in claim 1 further comprising:
determining if a current mode of operation of said PCIe card is a first mode of operation in response to said predicted bandwidth utilization of said PCIe link exceeding a threshold value; and
determining if there is currently traffic on said PCIe link involving said PCIe card in response to said current mode of operation of said PCIe card being in a second mode of operation.

5. The method as recited in claim 4 further comprising:
routing traffic to a different PCIe link in response to currently having traffic on said PCIe link involving said PCIe card; and
selecting a configuration setting of said PCIe card to implement said first mode of operation upon routing traffic to said different PCIe link.

6. The method as recited in claim 1 further comprising:
determining if a current mode of operation of said PCIe card is a second mode of operation in response to said predicted bandwidth utilization of said PCIe link not exceeding a threshold value; and
determining if there is currently traffic on said PCIe link involving said PCIe card in response to said current mode of operation of said PCIe card being in a first mode of operation.

7. The method as recited in claim 6 further comprising:
routing traffic to a different PCIe link in response to currently having traffic on said PCIe link involving said PCIe card; and
selecting a configuration setting of said PCIe card to implement said second mode of operation upon routing traffic to said different PCIe link.

8. A computer program product for maximizing bandwidth utilization of Peripheral Component Interconnect Express (PCIe) links, the computer program product comprising one or more computer readable storage mediums having program code embodied therewith, the program code comprising programming instructions for:
measuring a bandwidth utilization of a PCIe link involving a PCIe card;
predicating a bandwidth utilization of said PCIe link based on said measured bandwidth utilization of said PCIe link using a machine learning model trained to predict bandwidth utilizations of PCIe links; and
switching a mode of operation of said PCIe card based on said predicted bandwidth utilization of said PCIe link.

9. The computer program product as recited in claim 8, wherein the program code further comprises the programming instructions for:
selecting a configuration setting of said PCIe card to implement a first mode of operation in response to said predicted bandwidth utilization of said PCIe link exceeding a threshold value, wherein said first mode of operation is a later version of PCIe than a second mode of operation.

10. The computer program product as recited in claim 8, wherein the program code further comprises the programming instructions for:
selecting a configuration setting of said PCIe card to implement a second mode of operation in response to said predicted bandwidth utilization of said PCIe link not exceeding a threshold value, wherein said second mode of operation is an earlier version of PCIe than a first mode of operation.

11. The computer program product as recited in claim 8, wherein the program code further comprises the programming instructions for:
determining if a current mode of operation of said PCIe card is a first mode of operation in response to said predicted bandwidth utilization of said PCIe link exceeding a threshold value; and
determining if there is currently traffic on said PCIe link involving said PCIe card in response to said current mode of operation of said PCIe card being in a second mode of operation.

12. The computer program product as recited in claim 11, wherein the program code further comprises the programming instructions for:
routing traffic to a different PCIe link in response to currently having traffic on said PCIe link involving said PCIe card; and
selecting a configuration setting of said PCIe card to implement said first mode of operation upon routing traffic to said different PCIe link.

13. The computer program product as recited in claim 8, wherein the program code further comprises the programming instructions for:
determining if a current mode of operation of said PCIe card is a second mode of operation in response to said predicted bandwidth utilization of said PCIe link not exceeding a threshold value; and
determining if there is currently traffic on said PCIe link involving said PCIe card in response to said current mode of operation of said PCIe card being in a first mode of operation.

14. The computer program product as recited in claim 13, wherein the program code further comprises the programming instructions for:
routing traffic to a different PCIe link in response to currently having traffic on said PCIe link involving said PCIe card; and
selecting a configuration setting of said PCIe card to implement said second mode of operation upon routing traffic to said different PCIe link.

15. A system, comprising:
a memory for storing a computer program for maximizing bandwidth utilization of Peripheral Component Interconnect Express (PCIe) links; and
a processor connected to said memory, wherein said processor is configured to execute program instructions of the computer program comprising:
measuring a bandwidth utilization of a PCIe link involving a PCIe card;
predicating a bandwidth utilization of said PCIe link based on said measured bandwidth utilization of said PCIe link using a machine learning model trained to predict bandwidth utilizations of PCIe links; and
switching a mode of operation of said PCIe card based on said predicted bandwidth utilization of said PCIe link.

16. The system as recited in claim 15, wherein the program instructions of the computer program further comprise:
selecting a configuration setting of said PCIe card to implement a first mode of operation in response to said predicted bandwidth utilization of said PCIe link exceeding a threshold value, wherein said first mode of operation is a later version of PCIe than a second mode of operation.

17. The system as recited in claim 15, wherein the program instructions of the computer program further comprise:
selecting a configuration setting of said PCIe card to implement a second mode of operation in response to said predicted bandwidth utilization of said PCIe link not exceeding a threshold value, wherein said second mode of operation is an earlier version of PCIe than a first mode of operation.

18. The system as recited in claim 15, wherein the program instructions of the computer program further comprise:
determining if a current mode of operation of said PCIe card is a first mode of operation in response to said predicted bandwidth utilization of said PCIe link exceeding a threshold value; and
determining if there is currently traffic on said PCIe link involving said PCIe card in response to said current mode of operation of said PCIe card being in a second mode of operation.

19. The system as recited in claim 18, wherein the program instructions of the computer program further comprise:
routing traffic to a different PCIe link in response to currently having traffic on said PCIe link involving said PCIe card; and
selecting a configuration setting of said PCIe card to implement said first mode of operation upon routing traffic to said different PCIe link.

20. The system as recited in claim 15, wherein the program instructions of the computer program further comprise:
determining if a current mode of operation of said PCIe card is a second mode of operation in response to said predicted bandwidth utilization of said PCIe link not exceeding a threshold value; and
determining if there is currently traffic on said PCIe link involving said PCIe card in response to said current mode of operation of said PCIe card being in a first mode of operation.
